(19) United States
(12) Patent Application Publication
(10) Pub. No.: US 2006/0036822 A1
(43) Pub. Date: Feb. 16, 2006

(54) Method for managing a computer system having fibre-channel switch, management program, and management computer system

(76) Inventor: Tomoyuki Kaji, Yokohama (JP)

Correspondence Address: MATTINGLY, STANGER & MALUR, P.C.;ATTORNEYS AT LAW, SUITE 370, 1800 DIAGONAL ROAD, ALEXANDRIA, VA, 22314, US

(21) Appl. No.: 10/985,053

(22) Filed: Nov. 10, 2004

(30) Foreign Application Priority Data
Aug. 12, 2004 (JP) 2004-235389

(51) Int. Cl. G06F 12/14

(52) U.S. Cl. 711/163

(57) ABSTRACT

In a SAN where a zone has been set through hardware zoning, when any of devices connected to a fabric have been changed, the change is detected. Provided is a method for managing a devices in a Storage Area Network (SAN), each switch in the SAN comprising a memory and a plurality of ports that are connected to a computer and a storage subsystem, the method including obtaining a unique identifier from each of the computer and the storage subsystem connected to the ports, and storing the obtained identifier in the memory.

### CLAIM OF PRIORITY

The present application claims priority from Japanese application P2004-235389 filed on Aug. 12, 2004, the content of which is hereby incorporated by reference into this application.

### BACKGROUND OF THE INVENTION

This invention relates to a method for managing a devices in the Storage Area Network (SAN) (SAN is a network of storage and system components, all communicating on a Fibre Channel network), when any of devices connected to SAN have been changed (added or removed), system administrator detect the change, and restored. In particular, this invention relates to zoning of a SAN.

Realized as one form of a SAN (Storage Area Network) is a SAN which is formed by a fabric having one or more Fibre Channel switches (FC-SWs). By using the fabric, it also becomes possible to form a large-scale SAN. In a SAN formed by such a fabric, when it is desired to limit nodes (hosts and storage subsystems connected to the fabric) that are capable of communicating with each other, zoning is performed. Once a zoning is specified, nodes belonging to the zone and nodes not belonging to the zone become incapable of accessing each other. As a result, it becomes possible to prevent access from unauthorized nodes and leakage of data to the unauthorized nodes.

As to the zoning, there are hardware zoning and software zoning. The hardware zoning is also referred to as “port-based zoning”. The software zoning is also referred to as “WWN-based zoning”. With the hardware zoning, a zone is specified by designating the identifiers of physical ports on the switch. On the other hand, with the software zoning, a zone is specified by a port or node WWN (World Wide Name) (see W. Curtis Preston, “Using SANs & NAS”, O'Reilly & Associates, Inc., February, 2002, pp. 48 through 50, for instance). The port WWN is also referred to as “WWPN (World Wide Port Name)”. In general, the hardware zoning is adopted because its operation is easy.

### BRIEF SUMMARY OF THE INVENTION

With the hardware zoning, a zone is specified by the switch domain and port number. When devices (hosts and storage subsystems) are connected to the ports belonging to the zone, the devices belong to the zone. With the hardware zoning, even when any of the devices connected to the ports have been changed (“changed” means disconnected or other device is connected to the port), no influence is exerted on the zoning itself. Therefore, there is a case where even when any of the devices connected to the ports have been changed (“changed” means disconnected or other device is connected to the port) erroneously, a system administrator does not notice the change and continues operation of a system. Also, even when the system administrator notices the change, it is impossible for him/her to determine the devices connected before the change. Accordingly, it is impossible for the system administrator to restore an original connection.

According to this invention, there is provided a method for managing a devices in a Storage Area Network (SAN), each switch in the SAN comprising a memory and a plurality of ports that are connected to the computer and the storage subsystem, the method including: obtaining a unique identifier from each of the computer and the storage subsystem connected to the ports; and storing the obtained identifier in the memory.

According to this invention, unique identifiers obtained from nodes connected to ports are continuously stored even when the nodes connected to the ports have been changed. Therefore, when any of the devices connected to the ports constructing a zone have been changed, it is possible to detect the change while adopting the hardware zoning. As a result, it becomes possible for a system administrator to know the device change by receiving a notification while operating a system with ease like in the case of the hardware zoning. In addition, it becomes possible for the system administrator to restore a connection before the change.

### BRIEF DESCRIPTION OF THE DRAWINGS

FIG. 1 is a block diagram of a computer system according to an embodiment of this invention.

FIG. 2 is an explanatory diagram of the contents of a memory of an FC-SW according to the embodiment of this invention.

FIG. 3 is an explanatory diagram of a zone management table according to the embodiment of this invention.

FIG. 4 is an explanatory diagram of an alias management table according to the embodiment of this invention.

FIG. 5 is an explanatory diagram of a port management table according to the embodiment of this invention.

FIG. 6 is an explanatory diagram of a WWPN management table according to the embodiment of this invention.

FIG. 7 is an explanatory diagram of an alias-port mapping table according to the embodiment of this invention.

FIG. 8 is an explanatory diagram of a zone-alias mapping table according to the embodiment of this invention.

FIG. 9 is an explanatory diagram of a port list-display screen displayed on a display screen of a management terminal according to the embodiment of this invention.

FIG. 10 is an explanatory diagram of a zone list-display screen displayed on the display screen of a management terminal according to the embodiment of this invention.

FIG. 11 is a flowchart of lock request processing of an FC-SW management program according to the embodiment of this invention.

FIG. 12 is a flowchart of lock release processing of the FC-SW management program according to the embodiment of this invention.

FIG. 13 is a flowchart of port management table update processing of the FC-SW management program according to the embodiment of this invention.

FIG. 14 is a flowchart of zone management table update processing of the FC-SW management program according to the embodiment of this invention.

### DETAILED DESCRIPTION OF THE PREFERRED EMBODIMENTS

An embodiment of this invention will now be described with reference to the accompanying drawings.

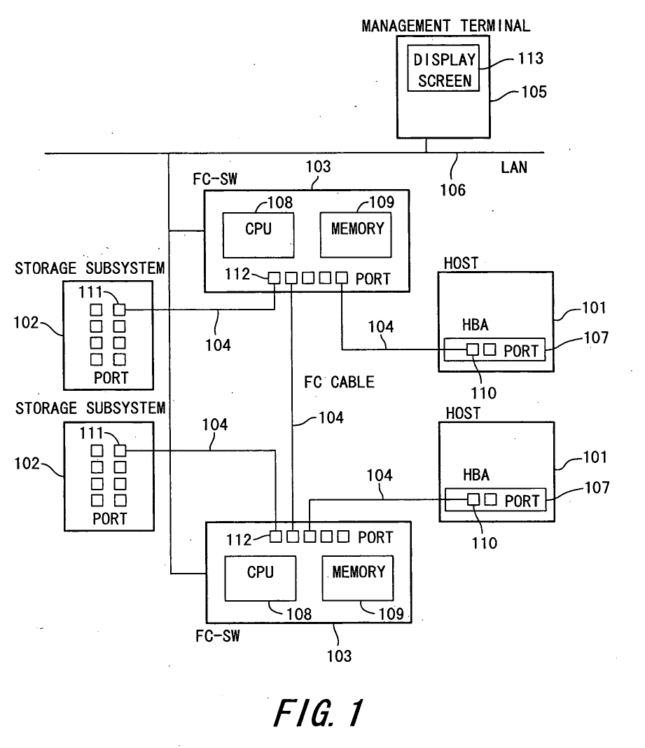

FIG. 1 is a block diagram of a computer system according to the embodiment of this invention.

The computer system shown in FIG. 1 includes hosts 101, storage subsystems 102, Fibre Channel switches (FC-SWs) 103, and a management terminal 105. The hosts 101 are communicably connected to the storage subsystems 102 by the FC-SWs 103 and Fibre Channel (FC) cables 104. The two FC-SWs 103 are communicably connected to each other by an FC cable 104. The management terminal 105 is communicably connected to the FC-SWs through a LAN 106.

The FC-SWs 103 and the FC cables 104 form a Storage Area Network (SAN) that communicably connects the hosts 101 and the storage subsystems 102 to each other.

Each host 101 includes at least a CPU (not shown), a memory (not shown), and a host bus adapter (HBA) 107. The HBA 107 is an interface that communicates with the storage subsystems through the FC-SWs 103, and includes ports 110 to which the FC cables 104 are connected. The CPU accesses the storage subsystems 102 through the ports 110 of the HBA 107 by executing an application program stored in the memory.

Each storage subsystem 102 is a disk array system formed of plural disk drives, for instance. The storage subsystem 102 includes ports 111 to which the FC cables 104 are connected and which communicate with the hosts 101 through the FC-SWs 103.

Each FC-SW 103 includes at least a CPU 108 that controls the FC-SW 103, a memory 109, and plural ports 112. As will be described later, an FC-SW management program and various tables are stored in the memory 109. In the memory 109, the e-mail address of a system administrator may also be stored. The CPU 108 is capable of setting connections between arbitrary plural ports 112 by executing the FC-SW management program.

The management terminal 105 is a computer including at least a CPU (not shown), a memory (not shown), an input device (not shown), and a display screen 113. The system administrator manages the FC-SWs 103 using the management terminal 105. The system administrator accesses the FC-SW management program through the LAN 106 to manage the FC-SWs 103. Alternatively, the system administrator may access the FC-SW management program through a telnet connection from the management terminal 105. As will be described later, information concerning the FC-SWs 103 is displayed on the display screen 113 of the management terminal 105.

It should be noted that one or more FC-SWs that are communicably connected to each other form a fabric. In FIG. 1, the two FC-SWs 103 that are communicably connected to each other by the FC cable 104 form one fabric.

Also, each device (such as the host 101 or the storage subsystem 102) connected to a port 112 of the fabric is also called the node.

It is possible for the system administrator to arbitrarily set a zone in the fabric. The zone is a logical group set in the fabric. Each node belonging to the zone is capable of communicating with other nodes belonging to the same zone but is incapable of communicating with nodes not belonging to the zone.

Next, the outline of this invention will be described with reference to FIG. 1.

In this embodiment, the system administrator sets a zone by designating the identifiers of the ports 112 of the fabric. In addition, it is possible for the system administrator to “lock” arbitrary ports 112. At this time, the World Wide Port Names (WWPNs) of the ports 110 and/or 111 of the devices (hosts 101 and/or storage subsystems 102) connected to the locked ports 112 are stored in the memory 109. Further, current time instants of each of WWPNs may be stored in the memory 109 associated with WWPNs.

Here, each WWPN is a unique identifier that uniquely identifies a port on a worldwide basis, is set for the port by a device manufacture, and will never be altered. Accordingly, there will never occur a situation where plural ports have the same WWPN.

It should be noted that in this embodiment, each device is identified using the WWPN as its unique identifier, although another unique identifier (World Wide Node Name (WWNN), for instance) may be used instead.

When any of the devices connected to the locked ports 112 have been changed to other devices, this results in a situation where some of the WWPNs stored as to the ports 112 in the memory 109 do not agree with the WWPNs of the ports 110 and/or 111 actually connected to the ports 112. The FC-SWs 103 compare these WWPNs and, when they do not agree with each other, judge that the device connection has been changed and issue a notification to the system administrator. WWPNs of the changed device and current time instant may be stored in the memory 109.

It is possible for the system administrator to know that the device connection in the zone has been changed by receiving this notification.

Also, when judging that a problem exists in the informed change (for instance, when the device connection has been changed without authorization), it is possible for the system administrator to take a countermeasure. For instance, the system administrator stops communication between each unauthorized device and other devices in the zone, to which the device belongs, or stops overall operation of the system. Further, it is possible for the system administrator to restore an original connection by referring to the WWPNs stored in the memory 109.

On the other hand, when judging that no problem exists in the informed change (when device connection has been temporarily changed due to device failure, for instance), it is possible for the system administrator to continue the operation of the system without any stops.

Also, when it is judged that the device connection has been changed, the FC-SW 103 may automatically stop communication between each device that is newly connected and other devices in the zone to which the device belongs.

Next, this invention will be described in detail.

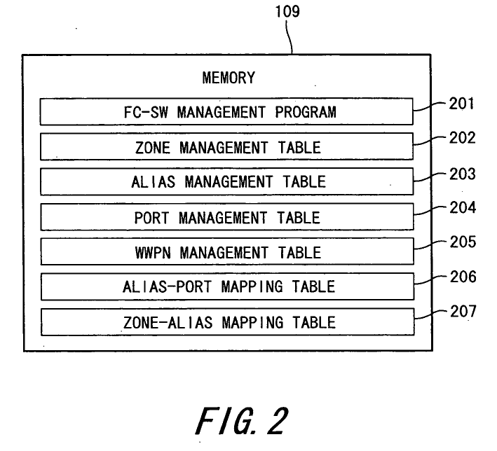

FIG. 2 is an explanatory diagram of the contents of the memory 109 of each FC-SW 103 according to the embodiment of this invention.

In the memory 109, at least an FC-SW management program 201, a zone management table 202, an alias management table 203, a port management table 204, a World Wide Port Name (WWPN) management table 205, an alias-port mapping table 206, and a zone-alias mapping table 207 are stored.

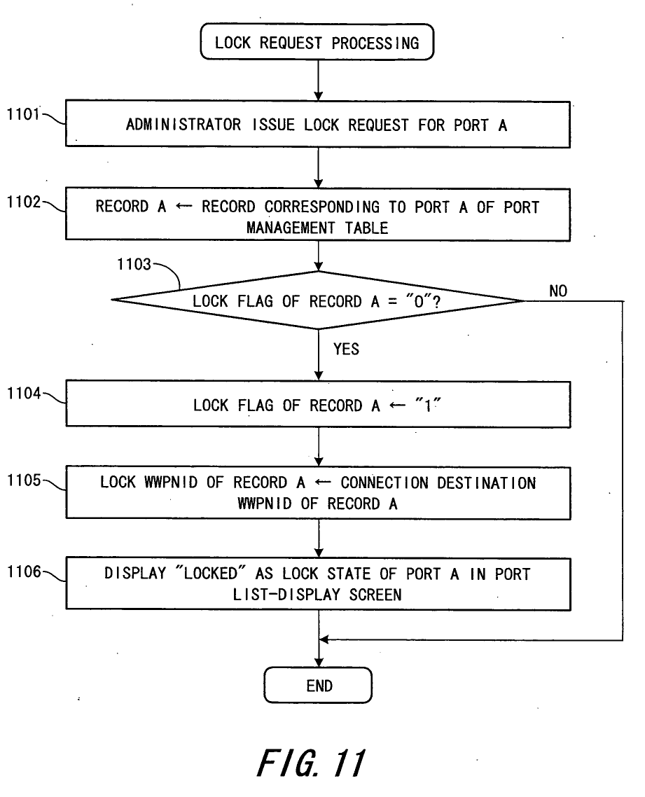

The FC-SW management program 201 is a program executed by the CPU 108 and manages the operation of the FC-SW 103. Processing contained in the FC-SW management program 201 will be described in detail later with reference to FIGS. 11 through 14.

In each of the tables 202 through 207, information necessary to manage the FC-SW 103 is recorded.

In the tables 202 through 207 of each of the FC-SWs 103 forming one fabric, the same values are stored. When a value stored in a table of one of the FC-SWs 103 is changed, the changed value is reflected in a corresponding table of the other of the FC-SWs 103 through the LAN 106 or the FC cable 104.

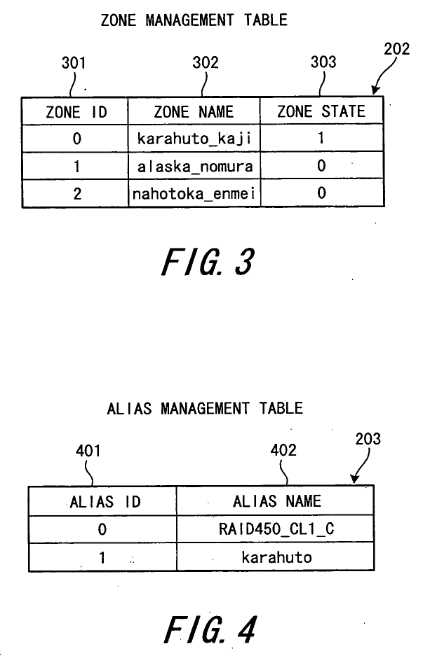

The contents of the tables 202 through 207 will be described in detail below with reference to FIGS. 3 through 8.

FIG. 3 is an explanatory diagram of the zone management table 202 according to the embodiment of this invention.

In this embodiment, at least one zone is set by designating the port numbers of the ports 112 of the fabric. The correspondences between the zone and the ports 112 forming the zone are specified by the zone-alias mapping table 207 shown in FIG. 8 and the alias-port mapping table 206 shown in FIG. 7, as will be described later.

The zone management table 202 shown in FIG. 3 is a table for managing the state of each zone set in the fabric.

Each zone ID 301 is the unique identifier of a zone set in the fabric.

Each zone name 302 is the name of a zone set in the fabric. This zone name 302 is set in order to facilitate system management. It is possible for the system administrator to arbitrarily set the zone name 302 unless the same zone name 302 is set for different zones.

Each zone state 303 is a flag showing the state of a zone. When the zone state 303 is set to “0”, this indicates that the zone is under a normal state. On the other hand, when the zone state 303 is set to “1”, this indicates that the zone is under an abnormal state. Here, the abnormal state refers to a state where at least one of the ports 112 belonging to the zone is locked and the device connected to the locked port 112 has been changed.

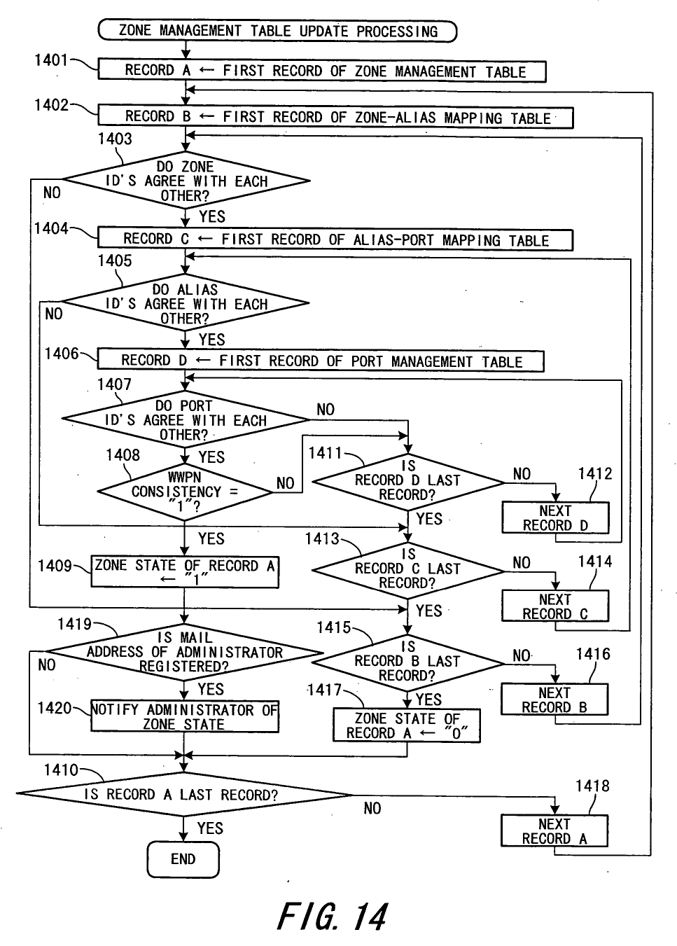

The zone state 303 is set and updated by zone management table update processing shown in FIG. 14 of the FC-SW management program 201.

In this embodiment, as shown in FIG. 3, three zones are set in the fabric and a zone “karahuto_kaji” among these zones is abnormal.

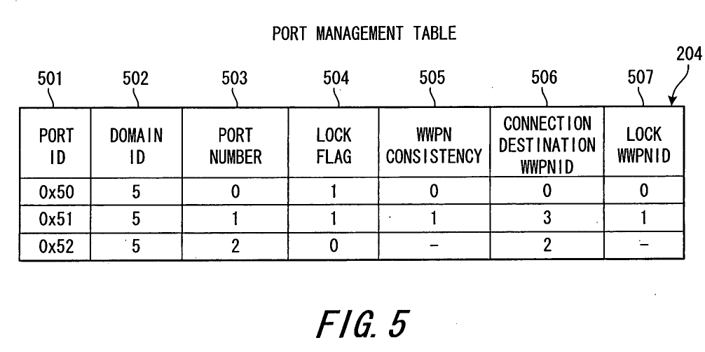

FIG. 4 is an explanatory diagram of the alias management table 203 according to the embodiment of this invention.

Each alias is a group composed of one or more ports 112 in the fabric. The alias is set in order to facilitate system management. The operation of the system is possible even when the alias is not set. However, when the alias is set, it becomes possible to give a name that is easy to understand intuitively (name or the like of the device connected to a port 112, for instance) to one port 112 or a group of ports 112, so the efficiency of system management improves.

The alias management table 203 is a table that manages each alias set in the fabric.

Each alias ID 401 is the unique identifier of an alias set in the fabric.

Each alias name 402 is the name of an alias. It is possible for the system administrator to arbitrarily set the alias name 402 unless the same alias name 402 is set for different aliases.

In this embodiment, as shown in FIG. 4, two aliases are set in the fabric.

FIG. 5 is an explanatory diagram of the port management table 204 according to the embodiment of this invention.

The port management table 204 is a table that manages each port 112 existing in the fabric. In the port management table 204, information about every port 112 existing in the fabric is stored. In FIG. 5, however, for ease of explanation, only information about three ports 112 is illustrated and information about other ports 112 is omitted.

In the port management table 204, each port ID 501 is the unique identifier of a port 112 belonging to the fabric.

Each domain ID 502 is the unique identifier of the FC-SW 103 to which a port 112 belongs.

Each port number 503 is the number with which a port 112 is uniquely identified in the domain (in other words, FC-SW 103) to which the port 112 belongs.

For instance, a port, whose port ID 501 is “0x50”, is the “0”th port of the FC-SW 103 whose domain ID 502 is “5”.

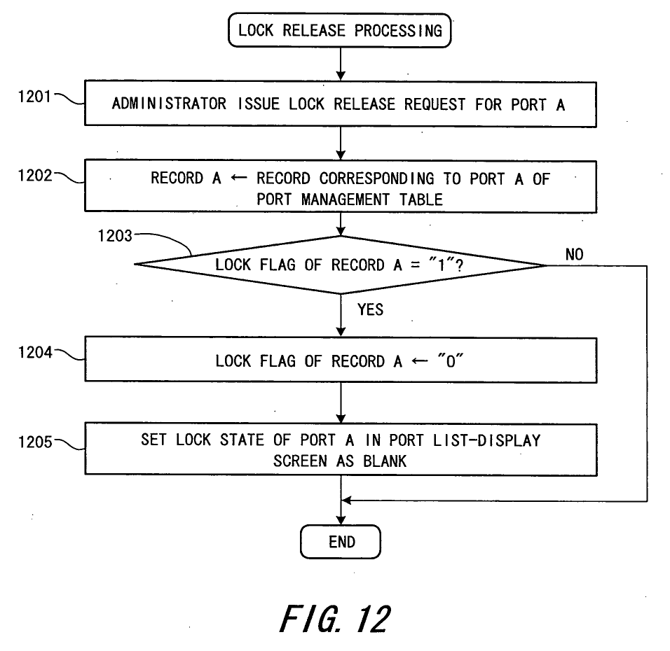

Each lock flag 504 is a flag showing whether a port 112 is locked. When the port 112 is locked, the value of the lock flag 504 is set to “1” (true). On the other hand, when the port 112 is not locked, the value of the lock flag 504 is set to “0” (false). The value of the lock flag 504 is set and updated by lock request processing shown in FIG. 11 and lock release processing shown in FIG. 12 of the FC-SW management program 201.

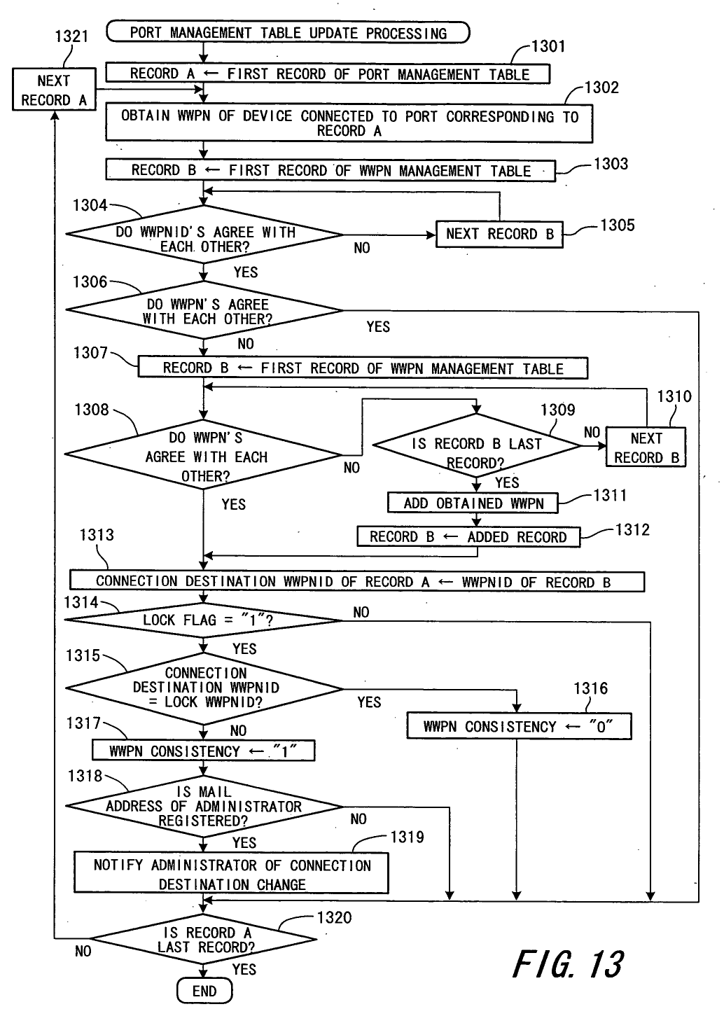

Each WWPN consistency 505 is a flag showing whether the value of the identifier of the WWPN stored as to a locked port 112 in the memory 109 (in other words, the value of a lock WWPNID 507 to be described later) agree with the value of the identifier of the WWPN actually connected to the port (in other words, the value of a connection destination WWPNID 506 to be described later). When they agree with each other, the value of the WWPN consistency 505 is set to “0”. On the other hand, when they do not agree with each other, the value of the WWPN consistency 505 is set to 1”. The value of the WWPN consistency 505 is set and updated by port management table update processing shown in FIG. 13 of the FC-SW management program 201.

It should be noted that the value of the WWPN consistency 505 of each port 112, whose lock flag 504 is set to “0”, is set blank because the port is not locked.

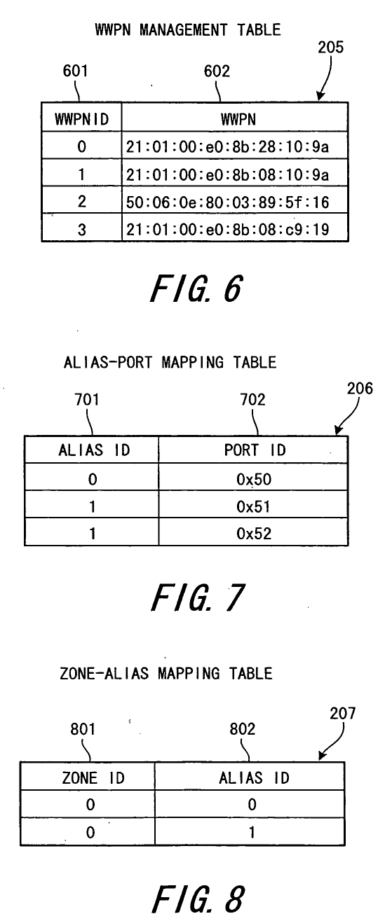

Each connection destination WWPNID 506 is the unique identifier shown in FIG. 6 of the WWPN of the port 110 or 111 of the device actually connected to a port 112. The value of the connection destination WWPNID 506 is set and updated by the port management table update processing shown in FIG. 13 of the FC-SW management program 201.

Each lock WWPNID 507 is the unique identifier shown in FIG. 6 of the WWPN of the port 110 or 111 of the device connected to a locked port 112 at a point in time when the port was locked. The value of the lock WWPNID 507 is set and updated by the lock request processing shown in FIG. 11 and the lock release processing shown in FIG. 12 of the FC-SW management program 201.

It should be noted that the value of the lock WWPNID 507 of each port 112, whose lock flag 504 is set to “0”, is set blank because the port is not locked.

In FIG. 5, a port “0x51” is locked and its values of the connection destination WWPNID 506 and the lock WWPNID 507 do not agree with each other. Therefore, the value of the WWPN consistency 505 of the port “0x51” is set to “1”. In other words, it is indicated that the device connected to the port “0x51” has been changed after the locking of the port “0x51”.

FIG. 6 is an explanatory diagram of the WWPN management table 205 according to the embodiment of this invention.

In the WWPN management table 205, each WWPNID 601 is the unique identifier of a port 110 or 111 that is connected to the fabric (or was previously connected thereto). The WWPNID 601 is automatically set by the FC-SW management program 201.

Each WWPN 602 is the WWPN of a port 110 or 111 that is connected to the fabric (or was previously connected thereto).

FIG. 7 is an explanatory diagram of the alias-port mapping table 206 according to the embodiment of this invention.

The alias-port mapping table 206 is a table showing the correspondences between the aliases set in the fabric and the ports 112 belonging to the aliases.

In the alias-port mapping table 206, each alias ID 701 is the unique identifier of an alias set in the fabric and corresponds to the alias ID 401 of the alias management table 203.

Each port ID 702 is the identifier of a port 112 belonging to an alias and corresponds to the port ID 501 of the port management table 204.

In the example shown in FIG. 7, ports “0x50” and “0x51” belong to an alias “0” set in the fabric according to this embodiment and a port “0x52” belongs to an alias “1” in the fabric.

FIG. 8 is an explanatory diagram of the zone-alias mapping table 207 according to the embodiment of this invention.

The zone-alias mapping table 207 is a table showing the correspondences between the zones set in the fabric and the aliases set in the zones.

In the zone-alias mapping table 207; each zone ID 801 is the unique identifier of a zone set in the fabric and corresponds to the zone ID 301 of the zone management table 202.

Each alias ID 802 is the unique identifier of an alias set in a zone and corresponds to the alias ID 401 of the alias management table 203.

In the example shown in FIG. 8, aliases “0” and “1” are set in a zone “0” according to this embodiment.

Ultimately, when FIGS. 3 through 8 are summarized, the port “0” (port “0x50”) of the domain (in other words, the FC-SW 103) “5” forming the fabric according to this embodiment forms the alias “0”, as can be seen from FIGS. 5 and 7. Also, the name of the alias “0” is “karahuto”, as shown in FIG. 4.

On the other hand, the ports “1” and “2” (ports “0x51” and “0x52”) of the domain “5” form the alias “1”, as can bee seen from FIGS. 5 and 7. Also, the name of the alias “1” is “RAID 450_CL1_C”, as shown in FIG. 4.

The ports “0x50”, “0x51”, and “0x52” form the zone “0”, as can be seen from FIGS. 7 and 8. Also, the name of the zone “0” is “karahuto_kaji”, as shown in FIG. 3.

The port “0x51” is locked and the device connected thereto has been changed, as can be seen from FIG. 5. Accordingly, the zone state 303 of the zone “0” is set to “1” (in other words, abnormal), as shown in FIG. 3.

In the fabric according to this embodiment, zones “1” and “2” are further set, as shown in FIG. 3. Also, the names of the zones are respectively “alaska_nomura” and “nahotoka_enmei”.

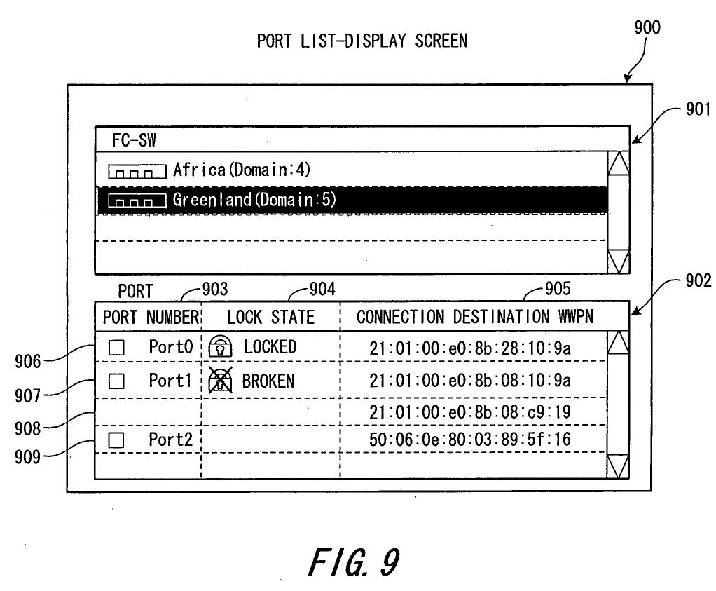

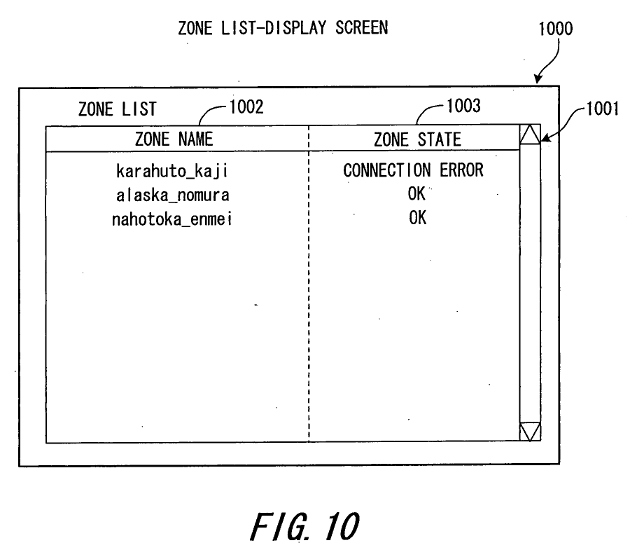

Next, contents displayed on the display screen 113 of the management terminal 105 when the system is under the state described above will be described with reference to FIGS. 9 and 10.

FIG. 9 is an explanatory diagram of a port list-display screen displayed on the display screen 113 of the management terminal 105 according to the embodiment of this invention.

A port list-display screen 900 is composed of a domain display area 901 and a port display area 902.

In the domain display area 901, every FC-SW 103 forming the fabric is list-displayed. In the example shown in FIG. 9, the fabric is formed by the two FC-SWs 103.

In the port display area 902, every port 112 forming an FC-SW 103 designated in the domain display area 901 is list-displayed. In the example shown in FIG. 9, the ports 112 forming the FC-SW “greenland” (domain “5”) are displayed.

Each port number 903 is the number that uniquely identifies a port 112 in the FC-SW (domain) and corresponds to the port number 503 of the port management table.

Each lock state 904 indicates whether a port is locked. When the port is locked, the lock state 904 also indicates whether its connection has been changed. In the example shown in FIG. 9, the port “0” is locked and its connection is not changed. Therefore, on line 906, as the lock state 904 of the port “0”, a word “LOCKED” and a figure of a padlock are displayed. The port “1” is locked and its connection has been changed. Therefore, on line 907, as the lock state 904 of the port “1”, words “BROKEN” and a figure where a sign “x” is superimposed on the padlock figure are displayed. The port “2” is not locked. Therefore, on line 909, the lock state 904 of the port “2” is set blank.

It should be noted that the padlock figure is displayed in order to allow the system administrator to intuitively grasp the lock state. Accordingly, there occurs no problem even when another figure is used or no figure is displayed.

Each connection destination WWPN 905 indicates the WWPN of the device connected to a port 112. This connection destination WWPN 905 corresponds to the WWPN 602 shown in FIG. 6. In the example shown in FIG. 9, the connection of the port “1” has been changed. A WWPN “21:01:00:e0:8b:08:10:9a” on line 907 indicates the WWPN of the device that was connected to the port “1” when this port was locked, while a WWPN “21:01:00:e0:8b:08:c9:19” on line 908 indicates the WWPN of the device that is currently connected to the port “1”.

It is possible for the system administrator to know that the connection of the locked port “1” has been changed by viewing the words “no lock destination” displayed as the lock state 904 on the display screen 113 of the management terminal 105. In addition, it is possible for the system administrator to know the WWPN of the device that was connected to the port “1” at a point in time when the port was locked by viewing the connection destination WWPN 905. Accordingly, it becomes possible for the system administrator to return the connection of the port “1” to a state at the point in time when the port was locked.

FIG. 10 is an explanatory diagram of a zone list-display screen displayed on the display screen 113 of the management terminal 105 according to the embodiment of this invention.

A zone list-display screen 1000 is composed of a zone list-display area 1001.

In a zone name column 1002 of the zone list display area 1001, the name of each zone set in the fabric is list-displayed. The zone name displayed in the zone name column 1002 corresponds to the zone name 302 of the zone management table 202.

In a zone state column 1003, the state of each zone is displayed. The zone state displayed in the zone state column 1003 corresponds to the zone state 303 of the zone management table 202. The zone state 303 of the zone “karahuto_kaji” is “1” (in other words, abnormal), as shown in FIG. 3. Therefore, a word “CONNECTION ERROR” is displayed in the zone state column 1003 for the zone “karahuto_kaji”.

It is possible for the system administrator to know that the state of the zone “karahuto_kaji” is abnormal by viewing the word “CONNECTION ERROR” in the zone state column 1003 displayed on the display screen 113 of the management terminal 105. In other words, it is possible for the system administrator to know that any of the connections of the locked ports 112 belonging to the zone “karahuto_kaji” have been changed.

Next, processing of the FC-SW management program 201 will be described with reference to flowcharts.

FIG. 11 is a flowchart of the lock request processing of the FC-SW management program 201 according to the embodiment of this invention.

First, in a step 1101, the system administrator issues a lock request for one of the ports 112, thereby starting the lock request processing. Here, the port designated by the lock request issued by the system administrator is set as the port A.

It is possible for the system administrator to issue the lock request by manipulating the port list-display screen 900 displayed on the management terminal 105. For instance, the system administrator may issue the lock request by manipulating the port number 903 of the port A displayed in the port display area 902 with a mouse or the like.

Alternatively, the system administrator may issue the lock request by inputting a command into the management terminal 105.

Next, in a step 1102, a record corresponding to the port A is read from the port management table 204 and is set as the record A. Here, the record is one line of the port management table 204.

Next, in a step 1103, it is judged whether the value of the lock flag 504 of the record A is “0”. When the value of the lock flag 504 of the record A is not “0”, the port A is already locked, so the processing ends.

On the other hand, when the value of the lock flag 504 of the record A is “0”, the port A is not yet locked. Therefore, next, in a step 1104, the value of the lock flag 504 of the record A is set to “1”.

Next, in a step 1105, the value of the connection destination WWPNID 506 of the record A is copied to the lock WWPNID 507 of the record A.

Next, in a step 1106, the word “LOCKED” and the padlock figure are displayed as the lock state 904 corresponding to the port A in the port display area 902 of the port list-display screen 900.

Then, the lock request processing ends.

It should be noted that it is also possible for the system administrator to register his/her e-mail address during the lock request processing (in the step 1101, for instance). In this case, the e-mail address is registered in the memory 109. The registered e-mail address is used as the destination of a notification issued in a step 1319 of FIG. 13 when any of the devices connected to the ports 112 have been changed or a notification issued in a step 1420 of FIG. 14 when any of the states of the zones become abnormal.

FIG. 12 is a flowchart of the lock release processing of the FC-SW management program 201 according to the embodiment of this invention.

First, in a step 1201, the system administrator issues a lock release request for one of the ports 112, thereby starting the lock release processing. Here, the port designated by the lock release request issued by the system administrator is set as the port A.

It is possible for the system administrator to issue the lock release in the same manner as the case of issuing the lock request.

Next, in a step 1202, a record corresponding to the port A is read from the port management table 204 and is set as the record A.

Next, in a step 1203, it is judged whether the value of the lock flag 504 of the record A is “1”. When the value of the lock flag 504 of the record A is not “1”, the port A is not yet locked, so the processing ends.

On the other hand, when the value of the lock flag 504 of the record A is “1”, the port A is locked. Therefore, next, in a step 1204, the value of the lock flag 504 of the record A is set to “0”.

Next, in a step 1205, the display of the word “LOCKED” and the padlock figure is deleted from the lock state 904 corresponding to the port A in the port display area 902 of the port list-display screen 900, which is then set as blank.

Then, the lock release processing ends.

FIG. 13 is a flowchart of the port management table update processing of the FC-SW management program 201 according to the embodiment of this invention.

First, the outline of the port management table update processing will be described.

In the port management table update processing, first, in steps 1301 through 1313, the connection destination WWPNID 506 corresponding to each port 112 in the port management table 204 is updated according to the WWPN of the device actually connected to the port 112. Since, the WWPN is not contained in the port management table 204, the WWPN management table 205 is referred to as necessary. Next, in steps 1314 through 1319, when the port 112 is locked, it is judged whether its device connection has been changed and, when a result of this judgment is affirmative, a notification showing the change is issued to the administrator.

Next, a procedure of the port management table update processing will be described in detail.

After the port management table update processing starts, first, in the step 1301, the first record of the port management table 204 is read and is set as the record A.

Next, in the step 1302, the WWPN of the device connected to the port 112 corresponding to the record A (in other words, the device connected to the port 112 corresponding to the domain ID 502 and the port number 503 of the record A) is obtained.

Next, the connection destination WWPNID 506 of the record A is updated according to the WWPN obtained in the step 1302. To do so, first, in the step 1303, the first record of the WWPN management table 205 is read and is set as the record B.

Next, in the step 1304, it is judged whether the connection destination WWPNID 506 of the record A and the WWPNID 601 of the record B agree with each other. When they do not agree with each other, the WWPN 602 of the record B is not the WWPN corresponding to the connection destination WWPNID 506 of the record A. Therefore, in the step 1305, a record next to the record B is read from the WWPN management table 205 and is set as a new record B. Then, the processing returns to the step 1304.

On the other hand, when the connection destination WWPNID 506 of the record A and the WWPNID 601 of the record B agree with each other, the WWPN 602 of the record B is the WWPN corresponding to the connection destination WWPNID 506 of the record A. Therefore, next, in the step 1306, it is judged whether the WWPN 602 of the record B and the WWPN obtained in the step 1302 agree with each other. When they agree with each other, the device connected to the port 112 corresponding to the record A is not changed, so it is not required to update the connection destination WWPNID 506 of the record A. Therefore, in order to perform the processing for the next record A, the processing proceeds to a step 1320.

On the other hand, when the WWPN 602 of the record B and the WWPN obtained in the step 1302 do not agree with each other, the device connected to the port 112 corresponding to the record A has been changed. Accordingly, it is required to update the connection destination WWPNID 506 of the record A to a value corresponding to the WWPN obtained in the step 1302. Therefore, next, in the step 1307, the first record of the WWPN management table 205 is read and is set as the record B.

Next, in the step 1308, it is judged whether the WWPN 602 of the record B and the WWPN obtained in the step 1302 agree with each other. When they agree with each other, the WWPN 602 of the record B is the WWPN corresponding to the connection destination WWPNID 506 of the record A. Therefore, next, in the step 1313, the WWPNID 601 of the record B is copied to the connection destination WWPNID 506 of the record A. As a result, the connection destination WWPNID 506 of the record A is updated according to the WWPN of the device actually connected.

On the other hand, when the WWPN 602 of the record B and the WWPN obtained in the step 1302 do not agree with each other, the WWPN 602 of the record B is not the WWPN corresponding to the connection destination WWPNID 506 of the record A. Therefore, next, in the step 1309, it is judged whether the record B is the last record of the WWPN management table 205.

When the record B is not the last record of the WWPN management table 205, the processing proceeds to the step 1310 in which a record next to the record B is read from the WWPN management table 205 and is set as a new record B. Then, the processing returns to the step 1308.

On the other hand, when the record B is the last record of the WWPN management table 205, the WWPN obtained in the step 1302 is not yet registered in the WWPN management table 205. Therefore, in the step 1311, the WWPN obtained in the step 1302 is additionally registered in the WWPN management table 205.

Next, in the step 1312, the record added in the step 1311 is set as the record B. Then, the processing proceeds to the step 1313.

Next, in the step 1314, it is judged whether the lock flag 504 of the record A is “1”.

When the lock flag 504 of the record A is “0”, the port 112 corresponding to the record A is not locked, so the processing proceeds to the step 1320.

On the other hand, when the lock flag 504 of the record A is “1”, the port 112 corresponding to the record A is locked. Therefore, next, in the step 1315, it is judged whether the connection destination WWPNID 506 and the lock WWPNID 507 of the record A agree with each other.

When the connection destination WWPNID 506 and the lock WWPNID 507 of the record A agree with each other, the device connected to the port 112 corresponding to the record A is not changed. Therefore, in the step 1316, the value of the WWPN consistency 505 of the record A is set to “0”. Then, the processing proceeds to the step 1320.

On the other hand, when the connection destination WWPNID 506 and the lock WWPNID 507 of the record A do not agree with each other, the device connected to the port 112 corresponding to the record A has been changed. Therefore, in the step 1317, the value of the WWPN consistency 505 of the record A is set to “1”.

It should be noted that a result of the operation in the step 1317 is reflected in the port list-display screen 900 displayed on the display screen 113 of the management terminal 105 through the LAN 106. In other words, as the lock state 904 corresponding to the port 112 whose value of the WWPN consistency 505 has been changed to “1”, the words “BROKEN” and the figure where the sign “x” is superimposed on the padlock figure are displayed.

Next, in the step 1318, it is judged whether the e-mail address of the system administrator is registered in the memory 109. It is possible for the system administrator to register his/her e-mail address in the memory 109 in advance. Alternatively, the system administrator may register his/her e-mail address at the time of issuing the lock request for the port 112 as shown in FIG. 11. When the e-mail address of the system administrator is not registered in the memory 109, the processing proceeds to the step 1320.

On the other hand, when the e-mail address of the system administrator is registered in the memory 109, an e-mail is transmitted to the address in the step 1319, thereby issuing a notification showing that the device connected to the port 112 corresponding to the record A has been changed to the system administrator.

It is possible for the system administrator to know that the device connected to the port 112 corresponding to the record A has been changed by receiving this e-mail. The e-mail contains every piece of information of the record A of the port management table 204 and information in the WWPN management table 205, for instance. In this case, it becomes possible for the system administrator to know the identifier of the port 112 whose connection has been changed, the WWPN of the device that was connected before the change, and the WWPN of the device that is currently connected. In other words, it becomes possible for the system administrator to identify the device that was connected to the port 112 at a point in time when the port was locked and to restore an original connection.

It should be noted that the value of the lock WWPNID 507 of the record A is held in the memory 109 until the lock of the port is released by the lock release processing shown in FIG. 12.

Next, in the step 1320, it is judged whether the record A is the last record of the port management table 204.

When the record A is not the last record, the update of every record of the port management table 204 is not yet completed. Therefore, in a step 1321, a record next to the record A is read from the port management table 204 and is set as a new record A. Then, the processing returns to the step 1302.

On the other hand, when the record A is the last record, the update of every record of the port management table 204 is completed. Therefore, the port management table update processing ends.

It is possible for the system administrator to execute the port management table update processing at an arbitrary point in time. Alternatively, the port management table update processing may be periodically executed at predetermined intervals (at intervals of several minutes, one hour, one day, or the like, for instance). When doing so, the port management table update processing updates the value of each required connection destination WWPNID 506 but does not update the value of its corresponding lock WWPNID 507. For instance, assuming that the port management table update processing is executed at intervals of five minutes, when any of the devices connected to the ports 112 have been changed, this change is reflected in the values of the connection destination WWPNIDs 506 corresponding to the ports 112 within five minutes. On the other hand, even when any of the connected devices have been changed, the values of the lock WWPNIDs 507 corresponding to the ports 112 are not changed unless their lock is released by the lock release processing shown in FIG. 12.

It should be noted that in the port management table update processing shown in FIG. 13, the device connection change judgment may be made only for the locked ports 112. When any of the devices connected to the locked ports 112 have been changed, a notification showing the change is issued to the administrator. In this case, in the step 1301, a record, whose lock flag 504 is “1”, of the port management table 204 is read and is set as the record A. Also, the judgment in the step 1314 is not made and the step 1315 is executed after the step 1313. Further, in the step 1321, the next record, whose lock flag 504 is “1”, is read and is set as a new record A. Then, the processing returns to the step 1302.

In this case, when the port list-display screen 900 shown in FIG. 9 is to be displayed in order to execute the lock request processing shown in FIG. 11, it is required to obtain the WWPNs of the devices connected to the ports 112.

FIG. 14 is a flowchart of the zone management table update processing of the FC-SW management program 201 according to the embodiment of this invention.

After the zone management table update processing is started, first, in a step 1401, the first record of the zone management table 202 is read and is set as the record A.

Next, in a step 1402, the first record of the zone-alias mapping table 207 is read and is set as the record B.

Next, in a step 1403, it is judged whether the zone ID 301 of the record A and the zone ID 801 of the record B agree with each other. When they do not agree with each other, the alias ID 802 of the record B does not belong to the zone corresponding to the record A. In this case, the processing proceeds to a step 1415.

On the other hand, when the zone ID 301 of the record A and the zone ID 801 of the record B agree with each other, the alias ID 802 of the record B belongs to the zone corresponding to the record A. Therefore, next, in a step 1404, the first record of the alias-port mapping table 206 is read and is set as the record C.

Next, in a step 1405, it is judged whether the alias ID 802 of the record B and the alias ID 701 of the record C agree with each other. When they do not agree with each other, the port ID 702 of the record C does not belong to the alias corresponding to the record B. In this case, the processing proceeds to a step 1413.

On the other hand, when the alias ID 802 of the record B and the alias ID 701 of the record C agree with each other, the port ID 702 of the record C belongs to the alias corresponding to the record B. In other words, the port ID 702 of the record C belongs to the zone corresponding to the record A. Therefore, next, in a step 1406, the first record of the port management table 204 is read and is set as the record D.

Next, in a step 1407, it is judged whether the port ID 702 of the record C and the port ID 501 of the record D agree with each other. When they do not agree with each other, the processing proceeds to a step 1411.

On the other hand, when the port ID 702 of the record C and the port ID 501 of the record D agree with each other, the port 112 corresponding to the record D belongs to the alias corresponding to the record C. In other words, the port 112 corresponding to the record D belongs to the zone corresponding to the record A. Therefore, next, in a step 1408, it is judged whether the WWPN consistency 505 of the record D is “1”. When the WWPN consistency 505 of the record D is “0”, the state of the zone corresponding to the record A is normal. In this case, next, the processing proceeds to the step 1411.

On the other hand, when the WWPN consistency 505 of the record D is “1”, the state of the zone corresponding to the record A is abnormal. Therefore, in a step 1409, the value of the zone state 303 of the record A is set to “1”.

It should be noted that a result of the operation in the step 1409 is reflected in the zone list-display screen 1000 displayed on the display screen 113 of the management terminal 105 through the LAN 106. In other words, in the zone state column 1003, the word “CONNECTION ERROR” is displayed for the zone whose value of the zone state 303 has been changed to “1”.

Next, in a step 1419, it is judged whether the e-mail address of the system administrator is registered in the memory 109. It is possible for the system administrator to register his/her e-mail address in the memory 109 in advance. Alternatively, the system administrator may register his/her e-mail address at the time of issuing the lock request for the port 112 as shown in FIG. 11. When the e-mail address of the system administrator is not registered in the memory 109, the processing proceeds to a step 1410.

On the other hand, when the e-mail address of the system administrator is registered in the memory 109, an e-mail is transmitted to the address in a step 1420, thereby issuing a notification showing that the state of the zone corresponding to the record A is abnormal to the system administrator.

It is possible for the system administrator to know that the state of the zone corresponding to the record A is abnormal by receiving this e-mail.

On the other hand, when it is judged in the step 1407 that the port ID 702 of the record C and the port ID 501 of the record D do not agree with each other or when it is judged in the step 1408 that the WWPN consistency 505 of the record D is “0”, it is judged in the step 1411 whether the record D is the last record of the port management table 204.

When the record D is not the last record of the port management table 204, the judgment in the step 1408 is not yet made for every record of the port management table 204. Therefore, in a step 1412, a record next to the record D is read from the port management table 204 and is set as a new record D. Then, the processing returns to the step 1407.

On the other hand, when it is judged in the step 1411 that the record D is the last record of the port management table 204 or when it is judged in the step 1405 that the alias ID 802 of the record B and the alias ID 701 of the record C do not agree with each other, it is judged in the step 1413 whether the record C is the last record of the alias-port mapping table 206.

When the record C is not the last record of the alias-port mapping table 206, the judgment in the step 1405 is not yet made for every record of the alias-port mapping table 206. Therefore, in a step 1414, a record next to the record C is read from the alias-port mapping table 206 and is set as a new record C. Then, the processing returns to the step 1405.

On the other hand, when it is judged in the step 1413 that the record C is the last record of the alias-port mapping table 206 or when it is judged in the step 1403 that the zone ID 301 of the record A and the zone ID 801 of the record B do not agree with each other, it is judged in the step 1415 whether the record B is the last record of the zone-alias mapping table 207.

When the record B is not the last record of the zone-alias mapping table 207, the judgment in the step 1403 is not yet made for every record of the zone-alias mapping table 207. Therefore, in a step 1416, a record next to the record B is read from the zone-alias mapping table 207 and is set as a new record B. Then, the processing returns to the step 1403.

On the other hand, when the record B is the last record of the zone-alias mapping table 207, the state of the zone corresponding to the record A is normal. Therefore, in a step 1417, the value of the zone state 303 of the record A is set to “0”.

Next, in the step 1410, it is judged whether the record A is the last record of the zone management table 202.

When the record A is not the last record of the zone management table 202, the update of every record of the zone management table 202 is not yet completed. Therefore, in a step 1418, a record next to the record A is read from the zone management table 202 and is set as a new record A. Then, the processing returns to the step 1402.

According to this invention described above, when a zone is set through hardware zoning, it becomes possible for the system administrator to arbitrarily lock each desired port 112 belonging to the zone. When doing so, the FC-SW 103 obtains the WWPN of the device connected to the locked port 112 and stores it in the memory 109. Following this, even when the device connected to the port 112 has been changed, unless the lock is released, the WWPN stored in the memory 109 when the port was locked is continuously stored without being changed. After that, at an arbitrary point in time, a WWPN obtained from the device connected to the port 112 and the WWPN stored in the memory 109 are compared with each other. When it is found as a result of this comparison that they do not agree with each other, it is judged that the device connected to the port 112 has been changed. Then, a notification showing that the connected device has been changed is issued to the system administrator by e-mail or through screen displaying.

As a result, it becomes possible for the system administrator to know that the device connected to the locked port 112 has been changed while operating a system with ease like in the case of the conventional hardware zoning. When knowing that the connected device has been changed, it is possible for the administrator to stop the operation of the system. Alternatively, the administrator may continue the system operation. In addition, it is possible for the system administrator to restore a state before the locked port connection change.

What is claimed is:

1. A method for managing a devices in a Storage Area Network, the method comprising:
obtaining a unique identifier of the device port on a Host Bus Adapter or a storage subsystem which is connected to the fabric port on a Fibre Channel switch when the device port is connected to the fabric port, and each port has a locked flag which value is true or false and each port has a locked identifier;
setting locked flag to false if the locked flag is true at the time the fabric port is designated;
setting locked flag to true if the locked flag is false at the time the fabric port is designated;
setting locked identifier to the identifier of the device port at the time locked flag is set to false from true; and
setting locked identifier to nothing at the time locked flag is set to true from false.

2. The method according to claim 1, further comprising comparing each current identifier newly obtained as to a designated port with its corresponding locked identifier, and judging whether the new identifier and the locked identifier agree with each other.

3. The method according to claim 2, further comprising issuing a notification to an administrator of the computer system when it is judged that the current identifier and the locked identifier do not agree with each other.

4. A method for managing a computer system comprising a computer, a storage subsystem, and a network that couples the computer and the storage subsystem, the network comprising one or more switches that are coupled to each other, each switch comprising a memory and a plurality of ports that are connected to the computer and the storage subsystem,
the method comprising:
obtaining a unique identifier from each of the computer and the storage subsystem connected to the ports; and
storing the obtained identifier in the memory.

5. The method according to claim 4, further comprising comparing each new identifier newly obtained as to a designated port with its corresponding old identifier stored in the memory before the new identifier is obtained, and judging whether the new identifier and the old identifier agree with each other.

6. The method according to claim 5, further comprising issuing a notification to an administrator of the computer system when it is judged that the new identifier and the old identifier do not agree with each other.

7. The method according to claim 6, wherein the notification issued to the administrator shows the new identifier and the old identifier.

8. The method according to claim 5, wherein the computer system further comprises a management terminal that is coupled to the one or more switches, the method further comprising displaying a result of a judgment on a display screen of the management terminal when it is judged that the new identifier and the old identifier do not agree with each other.

9. The method according to claim 8, wherein the new identifier and the old identifier are displayed.

10. The method according to claim 4, wherein a zone formed by the plurality of ports of the one or more switches is set, the method further comprising
comparing each new identifier newly obtained as to a designated port among the plurality of ports belonging to the zone with its corresponding old identifier stored in the memory before the new identifier is obtained to judge whether the new identifier and the old identifier agree with each other, and
judging whether the zone contains at least one designated port where the new identifier and the old identifier do not agree with each other.

11. The method according to claim 10, further comprising issuing a notification to an administrator of the computer system when it is judged that the zone contains at least one designated port where the new identifier and the old identifier do not agree with each other.

12. The method according to claim 10, wherein the computer system further comprises a management terminal that is coupled to the one or more switches, the method further comprising
displaying a result of a judgment on a display screen of the management terminal when it is judged that the zone contains at least one designated port where the new identifier and the old identifier do not agree with each other.

13. A program for managing a computer system comprising a computer, a storage subsystem, and a network that couples the computer and the storage subsystem, the network comprising one or more switches that are coupled to each other, each switch comprising a memory and a plurality of ports that are connected to the computer and the storage subsystem,
the program controlling the switch to execute the procedures of:
obtaining a unique identifier from each of the computer and the storage subsystem connected to the ports; and
storing the obtained identifier in the memory.

14. The program according to claim 13, further controlling the switch to execute the procedure of comparing each new identifier newly obtained as to a designated port with its corresponding old identifier stored in the memory before the new identifier is obtained, and judging whether the new identifier and the old identifier agree with each other.

15. The program according to claim 14, further controlling the switch to execute the procedure of notifying an administrator of the computer system of the new identifier and the old identifier when it is judged that the new identifier and the old identifier do not agree with each other.

16. The program according to claim 14, wherein the computer system further comprises a management terminal that is coupled to the one or more switches, the program further controlling the switch to execute the procedure of displaying a result of a judgment, the new identifier, and the old identifier on a display screen of the management terminal when it is judged that the new identifier and the old identifier do not agree with each other.

17. A computer system, comprising:
a computer;
a storage subsystem; and
a network that couples the computer and the storage subsystem,
the network comprising one or more switches that are communicably connected to each other,
each switch comprising a memory, a plurality of ports that are connected to the computer and the storage subsystem, and a control unit that manages the switch,
wherein the control unit:
obtains a unique identifier from each of the computer and the storage subsystem connected to the ports; and
stores the obtained identifier in the memory.

18. The computer system according to claim 17, wherein the control unit compares each new identifier newly obtained as to a designated port with its corresponding old identifier stored in the memory before the new identifier is obtained, and judging whether the new identifier and the old identifier agree with each other.

19. The computer system according to claim 18, wherein the control unit notifies an administrator of the computer system of the new identifier and the old identifier when it is judged that the new identifier and the old identifier do not agree with each other.

20. The computer system according to claim 18, further comprising a management terminal that is coupled to the one or more switches, wherein the control unit displays a result of the judgment, the new identifier, and the old identifier on a display screen of the management terminal when it is judged that the new identifier and the old identifier do not agree with each other.
